(19) United States
(12) Patent Application Publication
(10) Pub. No.: US 2011/0277517 A1
(43) Pub. Date: Nov. 17, 2011

(54) Locking device with magnetic actuation for doors

(75) Inventor: Giovanni Aschieri, Torino (IT)

(73) Assignee: BONAITI SERRATURE S.P.A., Calolziocorte (IT)

(21) Appl. No.: 12/933,515

(22) PCT Filed: Feb. 1, 2010
(86) PCT No.: PCT/EP2010/000585

§ 371 Date: Sep. 20, 2010

(30) Foreign Application Priority Data
Feb. 4, 2009 (IT) MI2009A000140

(51) Int. Cl. E05B 47/06; E05B 13/00; E05B 65/00

(52) U.S. Cl. 70/91

(57) ABSTRACT

Locking device with magnetic actuation which is reversible so as to be suitable both for right-hand doors and for left-hand doors, comprising a frontal plate (1) for the fixing on the impost wing of the door, a strike (21) for the fixing on the jamb of the door in a position which can be opposed to said frontal plate, a magnet housed inside said strike, a bolt, a second magnet (4) housed inside said bolt (3) and a driving mechanism made up of two pawls (13), (16), one (13) of which controlled by outside handle and the other (16) by inside handle, a slide (19) for the driving of the bolt (3) and a system for blocking the opening by outside handle, leaving, at the same time, opening by inside handle operational.

The present invention relates to a locking device with magnetic actuation for inside doors, provided with mechanisms for performing the operations of opening and of closure (passage function), with systems for blocking opening by outside handle (privacy function) and mechanisms for emergency release (emergency function) by inside handle, when the privacy function is inserted.

In the current state of the art the locking devices most commonly found on the market able to provide said functions are also referred to as latches and are based on a locking system with purely mechanical actuation. This system is made up of a bolt, a drive mechanism made up in turn of two pawls made to rotate one by the inside handle and the other by the outside handle, and a slide which, actuated by said pawls, is able to move the bolt.

The locking devices currently available commercially also comprise a so-called privacy element characterised by the presence of a tooth with shape complementary to that of a notch present on the pawl made to rotate by the outside handle. The privacy element can be actuated form the inside and, once inserted, means that the tooth mentioned above is restrained in the notch of the pawl actuated by the outside handle, in this way preventing the opening of the lock from the outside.

In the current state of the art the only locks able to provide these functions are based entirely on mechanisms of a mechanical nature.

The object of the present invention is that of providing a locking device with magnetic actuation for inside doors which is likewise able to perform simultaneously the passage, privacy and emergency functions, basing on an opening and closure mechanism with magnetic actuation thus providing characteristics of simplicity and strength.

A device according to the present invention will therefore be characterised by a structure comprising a frontal plate fixed in the impost wing of a door, a magnet housed inside a strike fixed in the jamb of the door in a position which can be set opposite said frontal plate, a bolt inside whereof a second magnet and a driving mechanism are placed which can perform the functions of blocking the opening by outside handle (privacy) and of immediate release by inside handle in the event of an emergency (emergency). The mechanism of opening and closure of the lock (passage) which constitutes the present invention is purely magnetic and is based on the linkage of the magnetic flows between the magnet in said bolt and the magnet in said strike (closure position) and on the linkage of the magnetic flows between the magnet in said bolt and said frontal plate (opening position).

One problem of the mechanical locking devices provided with systems for blocking of the opening by outside handle, is the risk of accidental enabling of said systems, when the lock is in the opening condition. The occurrence of this eventuality entails the blocking of the lock and, therefore, the impossibility of reopening the door whereon said lock has been mounted, with the risk of remaining locked out of the room.

Another object of the present invention is therefore that of providing a lock with magnetic actuation provided with the passage, privacy and emergency functions, which is able to prevent accidental enabling of the system for the blocking of the opening by outside handle.

This object is achieved by the present invention thanks to the special configuration of the bolt. The latter in fact is provided with a projecting structure which, when said bolt is retracted, i.e. the lock is in the opening position, is positioned below the privacy system preventing accidental enabling thereof.

Another essential feature, which the locking devices such as those described above must have, is reversibility, i.e. the possibility of performing mounting of the lock in such a way that the internal face of the later can be turned both towards the inside of the door and towards the outside.

In order to allow the possibility described above, the mechanical latch devices available commercially are characterised by a privacy system with the possibility of actuation from both faces, inside and outside, of the lock. When mounting the lock a choice has to be made of which of the two possibilities to make operational. The use of the double actuation increases the complexity of the manufacture and of the assembly, as well as the precision of the single parts.

The double actuation also doubles the functions but only one of the two will be used according to whether the lock is mounted in one direction or the other. This doubling renders fragile and easily breakable the parts which oppose opening of the lock when the latter is closed and blocked.

A further object of the present invention is, therefore, that of providing a lock with magnetic actuation provided with the passage, privacy and emergency functions, which can have features of reversibility and at the same time be able to ensure greater simplicity of manufacture and assembly of the parts which contrast the opening when the system is blocked as well as greater strength of the latter parts.

Thanks to the use of the magnetic actuation, in fact, it is possible to build a bolt of reversible form without the need for building a privacy system with double actuation.

In the present invention doubling of the resistance of the sections to break-in through forcing of the handle is achieved thanks to the concentration in a single space of one mechanism in place of two.

These and other features of the present invention will be made clearer by reading of the following detailed description, relating to a preferred embodiment of the present invention to be considered by way of a non-limiting example of the more general concepts claimed.

The following description refers to the accompanying drawings, in which:

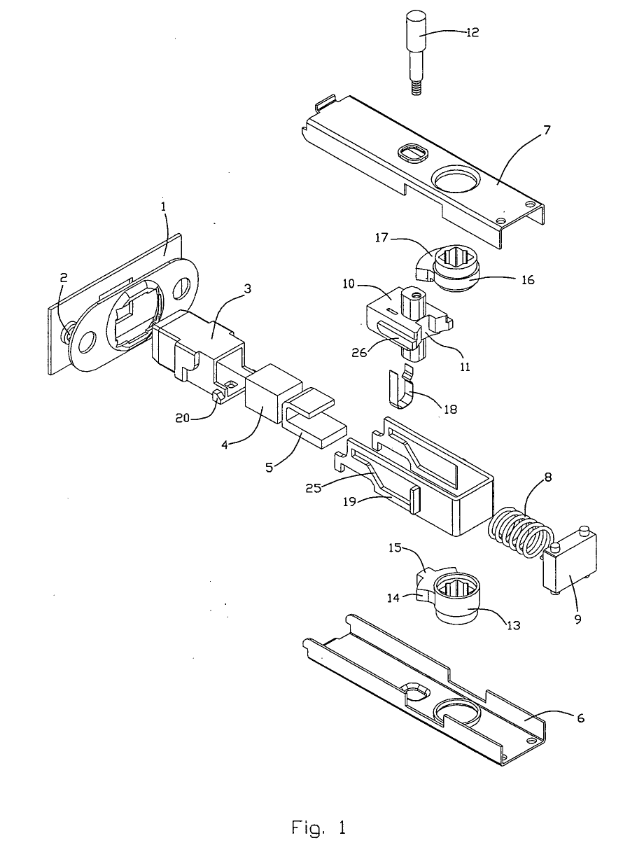

FIG. 1 is a blown-up view of the locking device with magnetic actuation;

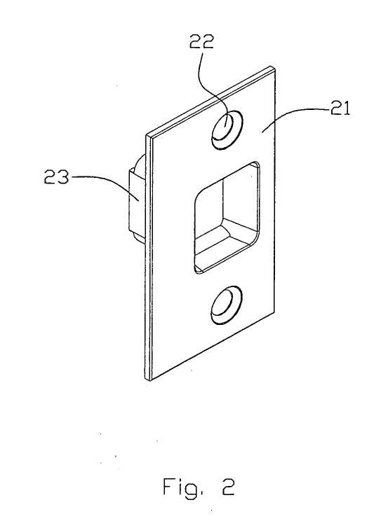

FIG. 2 is a perspective view of the detail of the strike;

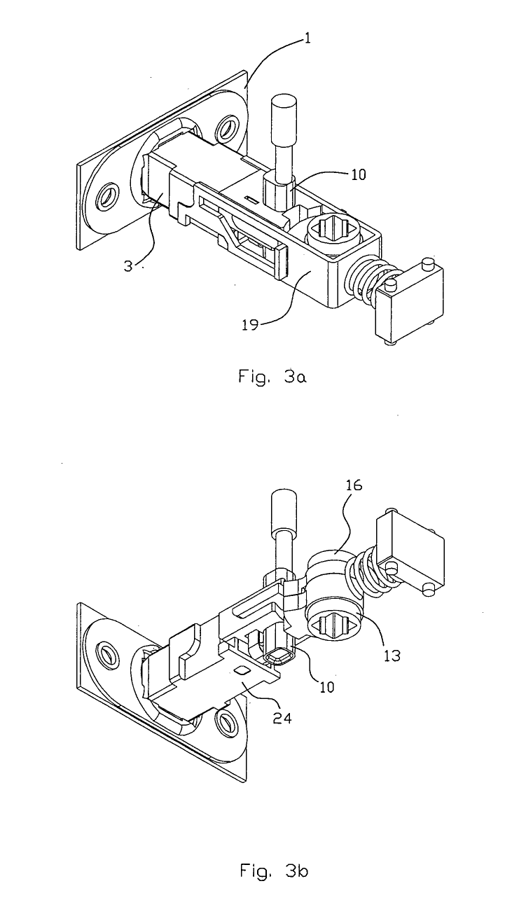

FIG. 3a is a perspective view from above of the locking device in the opening position without the side parts;

FIG. 3b is a perspective view from below of the detail representing the locking device in the opening position without the side parts and the slide for actuation of the bolt;

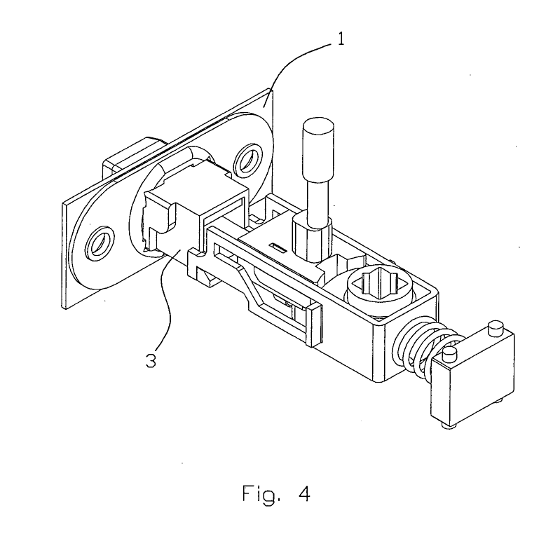

FIG. 4 is a perspective view of the locking device in the closure position with the privacy element for blocking of the lock by outside handle not inserted;

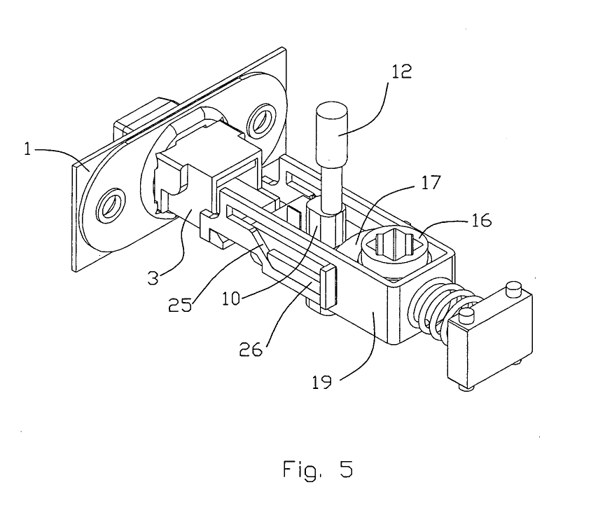

FIG. 5 is a perspective view of the locking device in the closure position with the privacy element for blocking of the lock by outside handle inserted.

In all the drawings the upper part of the device represents the part corresponding to the inside of the room where said device is used.

Referring to FIGS. 1 and 2, the locking device is made up of a frontal plate 1 provided with two through holes 2 for the mounting of said device on the door, a bolt 3 inside whereof a magnet 4 is housed, an element 5 for the blocking of the magnet, a driving mechanism, which will be described in detail herein below, positioned to the rear of said bolt 3, two side parts 6 and 7, a spring 8 for the return in conditions of rest and a back 9.

The driving mechanism is made up of the following elements:
an element 10 provided with a notch 11 for the blocking of opening by outside handle (privacy function) and of an element 12 for the activation of said blocking;
a control structure comprising two pawls:
(i) a pawl 13 which can be actuated by the outside handle and provided with a cam 14 with a tooth 15 of complementary shape to the notch 11 of the abovementioned element 10 for the performance of the privacy function;
(ii) a pawl 16 provided with a cam 17 without tooth which can be actuated by the inside handle;
a clip 18 with a U shape which ensures that the privacy element 10 does not move, in the case of accidental manoeuvres, from the position in which it finds itself;
a slide 19 which is able to move the bolt 3 backwards, when the latter is extracted from the lock, bringing the latter from the condition of closure to that of opening, by means of two projecting hooks 20. If the privacy function is not inserted, both the outside and inside handles are able to move the slide backwards. More particularly, when the pawl 13 with tooth is made to rotate by the outside handle, the cam 14 of said pawl 13 moves the slide 19 backwards which, in turn, by means of two projecting hooks 20, moves the bolt 3 backwards. Similarly, when the pawl 16 is made to rotate by the inside handle, the cam 17 of said pawl 16 moves the slide 19 backwards which, in turn, by means of the two projecting hooks 20, moves the bolt 3 backwards. All this is returned into a rest position by the spring 8.

The strike 21 shown in FIG. 2 is provided with two through holes 22 to allow attachment thereof on the jamb. To the rear of the strike there is a housing 23 inside whereof there is a second magnet capable of attracting the bolt 3 when the door is moved close to the rabbet.

The magnet present inside the bolt 3 and the magnet placed inside the housing 23 of the strike 21 are positioned in such a way as to have the poles aligned in the direction parallel to the axis of the movement of the bolt 3, according to the principle of functioning already described in the patent application U.S. Ser. No. 11/825,359 in the name of Bonaiti Serrature S.p.A. and as will be described in detail herein below.

Referring to FIGS. 3a and 3b, when the lock is in the opening position the bolt 3 is completely retracted, both the pawls 13 and 16 are in a rest position and the privacy element 10 is disabled. The slide 19 is maintained in a rest condition by means of the spring 8. The bolt 3 remains retracted thanks to the presence of the magnet inside said bolt. The configuration of the magnetic fields in fact means that said magnet is held in a backward position by the ferromagnetic frontal plate 1 which avoids the exiting thereof when the door is open. When the lock is in the opening position the privacy element cannot be inserted since when the bolt 3 is retracted a projecting part 24 of the latter is inserted below the privacy element 10.

Referring to FIGS. 2 and 4, when the lock is in the closure position the magnets present in the bolt 3 and in the strike 21 are adjacent and the bolt 3 is in a forward position in relation to the frontal plate 1.

Referring to FIGS. 1, 2 and 5, when the lock is in the closure position and is blocked so that it cannot be opened by moving the outside handle, the magnets present in the bolt 3 and in the strike 21 are adjacent, the bolt 3 is in a forward position in relation to the frontal plate 1, the element 10 has been activated by the element 12 and the tooth 15 of the pawl 13 is restrained in the notch 11 of the element 10. Thanks to the restraining of said tooth 15 of the pawl 13 in the notch 11 of the element 10 the outside handle is not able to activate said pawl 13.

Even if the lock is blocked by enabling of privacy, it is possible to release it through the action of the inside handle (emergency function).

Referring to FIGS. 1 and 5, in fact, the action of the inside handle makes the pawl without tooth rotate. The movement of the cam 17 of said pawl 16 causes the backward movement of the slide 19 which, by means of the two cams 25 which act on the two fins 26 of the privacy element 10, raises the same element and consequently removes the tooth 15 of the pawl 13 from the notch 11. In this way the actuation by inside handle restores the conditions of the locking device as released and which can be actuated by inside handle and by outside handle.

The possibility is also foreseen of having access from the outside to the privacy element, in the case of an emergency, by means of a small hole formed in the rosette of the handle and pushing, for example with a small screwdriver, the privacy element into a lock release position.

A locking device is thus obtained which is much simpler and stronger than the complex and entirely mechanical locking devices currently available commercially.

1-12. (canceled)

13. A locking device with magnetic actuation for doors, comprising:
a frontal plate for the fixing on an impost wing of the door,
a strike for the fixing on a jamb of the door in a position which can be opposed to said frontal plate,
a bolt and
a mechanism for driving said bolt, and
a control structure,
characterized in that said locking device comprises:
at least one magnet housed inside said bolt and
said driving mechanism is made up of a slide for driving the bolt,
a spring for maintaining the slide in conditions of rest,
an element for the blocking of the opening of said locking device by only an outside handle and not by an inside handle,
this being obtained by means of the use of a control structure comprising:
a pawl controlled by the outside handle but not by the inside handle and
a pawl controlled by inside handle.

14. The locking device with magnetic actuation for doors according to claim 13, characterized in that said element for the blocking of said locking device can be actuated only from the inside.

15. The locking device with magnetic actuation for doors according to claim 13, characterized in that said pawl controlled by the outside handle is provided with a tooth for the performance of the blocking of said locking device.

16. The locking device with magnetic actuation for doors according to claim 13, characterized in that said element for the blocking of said locking device is provided with a notch with a shape complementary to that of said tooth of said pawl controlled by the outside handle.

17. The locking device with magnetic actuation for doors according to claim 13, characterized in that when said tooth of said pawl controlled by the outside handle is restrained in said notch of said element for the blocking of the opening of said locking device by the outside handle, the locking device cannot be released by the outside handle.

18. The locking device with magnetic actuation for doors according to claim 13, characterized in that when said tooth of said pawl controlled by the outside handle is restrained in said notch of said element for the blocking of the opening of said locking device by outside handle, the locking device can be released by the inside handle by means of the pawl controlled by the inside handle.

19. The locking device with magnetic actuation for doors according to claim 13, characterized in that said bolt is provided with a structure which, positioning below said element for the blocking of the opening by outside handle, prevents the insertion of said element for the blocking of the opening by the outside handle when the door is open.

20. The locking device with magnetic actuation for doors according to claim 13, characterized in that it is reversible and can therefore be mounted with the inside face turned both towards the inside and towards the outside of the door.

21. The locking device with magnetic actuation for doors according to claim 13, characterized in that it is provided with control pawls with universal housing both for the pins of knobs and for the pins of handles.

22. The locking device with magnetic actuation for doors according to claim 13, characterized in that it is possible to release the element of blocking of the opening by outside handle by the insertion of a tool in a small hole formed in the rosette of the outside handle.

23. The locking device with magnetic actuation for doors according to claim 13, characterized in that it has a prismatic shape and has a section with a diameter of one inch at most.

24. The locking device with magnetic actuation for doors according to claim 13, characterized in that the resistance of the sections to break-in through forcing of the handle is doubled compared to that of purely mechanical latches.
